(19) United States
(12) Patent Application Publication
(10) Pub. No.: US 2018/0007298 A1
(43) Pub. Date: Jan. 4, 2018

(54) IMAGING DEVICE

(71) Applicant: RENESAS ELECTRONICS CORPORATION, Tokyo (JP)

(72) Inventors: Tetsuya IIDA, Ibaraki (JP); Yasutaka NAKASHIBA, Ibaraki (JP)

(21) Appl. No.: 15/639,231

(22) Filed: Jun. 30, 2017

(30) Foreign Application Priority Data
Jul. 4, 2016 (JP) 2016-132670

(51) Int. Cl. H04N 5/378; H04N 5/376; H04N 5/341; H04N 5/3745

(52) U.S. Cl. CPC H04N 5/378; H04N 5/3765; H04N 5/341; H04N 5/3745

(57) ABSTRACT

To provide an imaging device capable of reducing the amount of data with a simple method. An imaging device includes: a plurality of sensor elements which is arranged in a matrix shape and each of which generates a photoelectric conversion voltage in accordance with an input light level; and a read circuit which is coupled to bit lines provided while being associated with respective columns of the sensor elements, and amplifies and reads the photoelectric conversion voltages generated in the sensor elements by being exposed at predetermined timing. The read circuit outputs differential data of the read photoelectric conversion voltages generated in the respective sensor elements that are adjacent to each other in the same row or column.

### CROSS-REFERENCE TO RELATED APPLICATIONS

The disclosure of Japanese Patent Application No. 2016-132670 filed on Jul. 4, 2016 including the specification, drawings and abstract is incorporated herein by reference in its entirety.

### BACKGROUND

The disclosure relates to an imaging device.

An image sensor is used as a sensor to convert optical image information captured from the outside into an electric signal in a television camera or the like, and has a configuration in which a plurality of pixels is arranged on a plane in a matrix shape. The image sensor has a photodiode or a phototransistor, and peripheral circuits thereof are pixel circuits configured using MOS-type transistors. The various types of image sensors have been proposed (Japanese Unexamined Patent Application Publication No. 2000-175107).

### SUMMARY

On the other hand, in the case where a plurality of pixels is arranged, the amount of data tends to be increased because date is obtained on a pixel basis.

The disclosure has been made to solve the above-described problem, and an object thereof is to provide an imaging device capable of reducing the amount of data with a simple method.

The other objects and novel features will become apparent from the description of the specification and the accompanying drawings.

According to an embodiment, an imaging device includes: a plurality of sensor elements which is arranged in a matrix shape and each of which generates a photoelectric conversion voltage in accordance with an input light level; and a read circuit which is coupled to bit lines provided while being associated with respective columns of the sensor elements, and amplifies and reads the photoelectric conversion voltages generated in the sensor elements by being exposed at predetermined timing. The read circuit outputs differential data of the read photoelectric conversion voltages generated in the respective sensor elements that are adjacent to each other in the same row or column.

According to the embodiment, it is possible to provide an imaging device capable of reducing the amount of data with a simple method.

### BRIEF DESCRIPTION OF THE DRAWINGS

FIG. 1 is a diagram for explaining a configuration of an imaging device 1 on the basis of a first embodiment;

FIG. 2 is a diagram for explaining a configuration of each unit pixel;

FIG. 3 is a diagram for explaining a timing chart of the imaging device 1 on the basis of the first embodiment;

FIG. 4 is a diagram for explaining an image on the basis of image data imaged by the imaging device 1 on the basis of the first embodiment;

FIG. 5 is a schematic view in the case where differential data on the basis of the first embodiment is output;

FIG. 6 is a diagram for explaining another timing chart of the imaging device 1 on the basis of the first embodiment;

FIG. 7 is a diagram for explaining an image on the basis of different image data imaged by the imaging device 1 on the basis of the first embodiment;

FIG. 8 is a functional block diagram for showing an entire configuration of an imaging device 1# on the basis of a second embodiment;

FIG. 9 shows an example of images that can be displayed on a display unit 9 on the basis of image data stored in a memory 8 on the basis of the second embodiment;

FIG. 10 is a flowchart for explaining a compression method of image data on the basis of the second embodiment; and

FIG. 11 is a diagram for explaining a configuration of a unit pixel on the basis of a modified example.

### DETAILED DESCRIPTION

Embodiments will be described in detail with reference to the drawings. It should be noted that the same or corresponding parts will be followed by the same signs in the drawings, and the explanation thereof will not be repeated.

### First Embodiment

### <A. Configuration of Imaging Device>

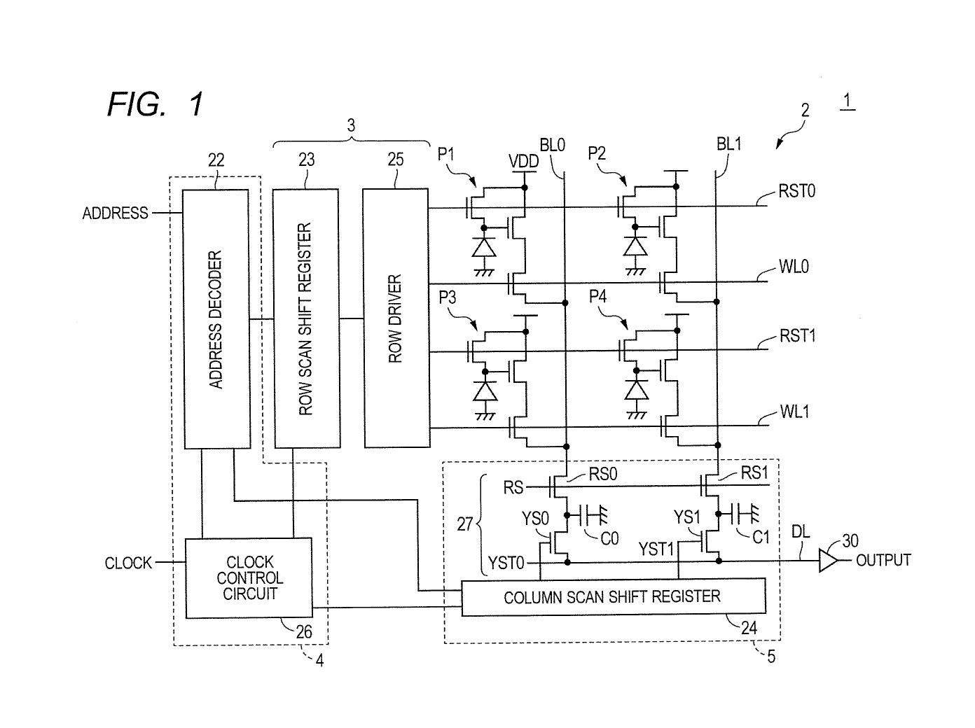

FIG. 1 is a diagram for explaining a configuration of an imaging device 1 on the basis of a first embodiment.

As shown in FIG. 1, the imaging device 1 includes a pixel array unit 2, a horizontal driving unit 3, a control unit 4, a vertical driving unit 5, and an amplifier 30.

In the pixel array unit 2, unit pixels P (sensor elements) are arranged in a matrix shape. Each of the unit pixels includes a photoelectric conversion area in which incident light is converted into electricity and an electric charge in accordance with the incident light is accumulated.

The pixel array unit 2 includes a word line and a reset line provided for each row of the unit pixels P. Further, the pixel array unit 2 includes a bit line provided for each column of the unit pixels P.

In the example, four unit pixels P1 to P4 (hereinafter, generally referred to as a unit pixel P in some cases) are arranged in a matrix shape.

Further, a word line WL and a reset line RST are provided for each row. The example shows a case in which word lines WL0 and WL1 and reset lines RST0 and RST1 are provided.

Further, a bit line BL is provided for each column. The example shows a case in which bit lines BL0 and BL1 are provided.

The horizontal driving unit 3 drives the word line WL and the reset line RST provided in the pixel array unit 2.

The horizontal driving unit 3 includes a row scan shift register 23 and a row driver 25.

The row scan shift register 23 generates a row address that is sequentially shifted from a head address in the vertical direction in accordance with a timing signal from a clock control circuit 26, and supplies the same to the row driver 25. The row driver 25 drives the reset line RST and the word line WL corresponding to the row address in the pixel array unit 2 in accordance with the row address.

The control unit 4 generates and outputs various control signals for controlling the horizontal driving unit 3 and the vertical driving unit 5 on the basis of an input address.

The control unit 4 includes an address decoder 22 and the clock control circuit 26.

The clock control circuit 26 outputs a timing signal for controlling each circuit in accordance with inputting of a clock from the outside.

The address decoder 22 generates head addresses in the vertical direction and the horizontal direction in accordance with an address signal from the outside, and supplies the same to the row scan shift register 23 and a column scan shift register 24.

The vertical driving unit 5 drives the bit line BL provided in the pixel array unit 2.

The vertical driving unit 5 includes the column scan shift register 24 and a column selection circuit 27.

The column scan shift register 24 generates a column address that is sequentially shifted from a head address in the horizontal direction in accordance with the timing signal from the clock control circuit 26, and drives the bit line BL corresponding to the column address in the pixel array unit 2.

The column selection circuit 27 includes a data line DL, transistors RS0 and RS1, transistors YS0 and YS1 (referred to as a transistor YS in some cases), and capacitors C0 and C1 (generally referred to as a capacitor C in some cases).

The transistors RS0 and YS0 are coupled to each other in series between the bit line BL0 and the data line DL.

The transistors RS1 and YS1 are coupled to each other in parallel with the transistors RS0 and YS0 and are coupled to each other in series between the bit line BL1 and the data line DL.

The capacitor C0 is provided between a fixed voltage and a coupling node that is provided between the transistors RS0 and YS0.

The capacitor C1 is provided between a fixed voltage and a coupling node that is provided between the transistors RS1 and YS1.

The transistors RS0 and RS1 become conductive in accordance with inputting of a control signal RS, and electrically couple the bit lines BL0 and BL1 to the capacitors C0 and C1, respectively. Accordingly, electric charges on the basis of photoelectric conversion voltages are accumulated into the capacitors C0 and C1 through the bit lines BL0 and BL1.

The transistor YS0 becomes conductive in accordance with inputting of a column selection signal YST0, and electrically couples the capacitor C0 to the data line DL.

The transistor YS1 becomes conductive in accordance with inputting of a column selection signal YST1, and electrically couples the capacitor C1 to the data line DL.

The column scan shift register 24 sequentially activates and shifts the column selection signal YST. Accordingly, the voltage on the basis of the electric charge of the capacitor C accumulated in accordance with the photoelectric conversion voltage of the unit pixel P is output to the data line DL.

Reset signals RST0 and RST1 are sequentially supplied from the row driver 25 in the beginning of an operation cycle, so that photodiodes are charged in the unit pixels P1 to P4. Next, exposure is performed by turning off the reset signals, and each word line WL is sequentially supplied after an arbitrary period of time, so that the amplified photoelectric conversion voltage of the unit pixel P is output to the bit lines BL0 and BL1. Further, the transistors RS0 and RS1 are turned on by supplying the control signal RS, so that the signal voltages of the bit lines BL0 and BL1 are held in capacitors C0 and C1, respectively.

Next, the transistors RS0 and RS1 are turned off, and the transistors YS0 and YS1 are turned on by supplying the column selection signals YST0 and YST1, so that the signal voltages held in the capacitors C0 and C1 are sequentially output.

The amplifier 30 amplifies and outputs the voltage of the data line DL.

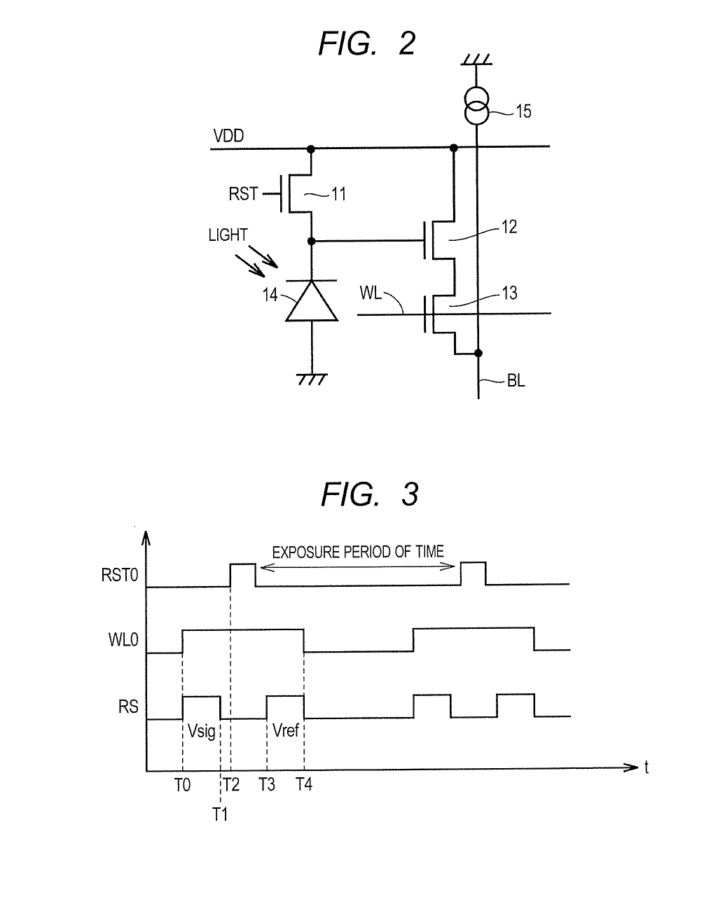

FIG. 2 is a diagram for explaining a configuration of each unit pixel.

As shown in FIG. 2, a configuration of the unit pixel P (sensor element) is shown.

In the example, the unit pixel P is configured using an N-channel transistor.

The unit pixel P in the example includes a transistor 11 for resetting, a transistor 12 for amplifying, a transistor 13 for outputting to the bit line, a photodiode 14, and a current source 15. In the example, the transistor 12 and the transistor 13 are enhancement-type transistors. However, the transistor 11 is a depression-type transistor.

The transistor 11 is coupled between a power supply voltage VDD and the photodiode 14. The gate of the transistor 11 is coupled to the reset line RST.

The transistors 12 and 13 are coupled to each other in series between the power supply voltage and the bit line BL.

The gate of the transistor 12 is coupled to an inner node between the transistor 11 and the photodiode 14.

The gate of the transistor 13 is coupled to the word line WL.

When the reset line RST becomes the “H” level, the transistor 11 supplies the power supply voltage VDD to the photodiode 14, and thus resets to a beginning state of the photoelectric conversion operation.

The transistor 12 forms a source follower together with the current source 15, and amplifies the photoelectric conversion voltage of the photodiode 14.

When the word line WL becomes the “H” level, the transistor 13 is turned on, and allows the transistor 12 to be coupled to the current source 15 through the bit line BL. The photodiode 14 generates a photoelectric conversion voltage in accordance with a light input level. Further, when the transistor 13 is turned on, the current source 15 supplies a current to the transistor 12 to operate as a source follower.

An operation of the unit pixel P in the example will be described.

In an unexposed state, the transistor 11 is activated in accordance with the reset line RST, and the photodiode 14 is initialized by being charged to the power supply voltage VDD. Then, the exposure of the photodiode 14 is started.

The photoelectric conversion voltage generated in the photodiode 14 in accordance with an input light level by the photoelectric effect of the photodiode 14 on the basis of inputting of light is amplified by the transistor 12 forming a source follower in accordance with the transconductance thereof. Then, the word line WL is activated after an arbitrary period of time to allow the transistor 13 to become conductive.

Then, the signal amplified by the transistor 12 is output to the bit line BL.

### B. Explanation of Operation>

FIG. 3 is a diagram for explaining a timing chart of the imaging device 1 on the basis of the first embodiment.

In the example, the unit pixel P1 will be described.

As shown in FIG. 3, the word line WL0 is selected (“H” level) at time T0. Accordingly, each unit pixel corresponding to the word line WL0 is selected. Then, the photoelectric conversion voltage generated in the unit pixel P1 corresponding to the word line WL0 is output to the bit line.

Further, the control signal RS is set at the “H” level, and the photoelectric conversion voltage is stored into the capacitor C.

A photoelectric conversion voltage Vsig stored in the capacitor C is output after being amplified by the amplifier 30 through the data line DL.

The control signal RS is set at the “L” level at time T1, and a transistor RS provided between the bit line BL and the capacitor becomes a non-conductive state.

The reset line RST0 is activated to the “H” level at time T2. Accordingly, the unit pixel corresponding to each word line WL0 is reset to a beginning state of the photoelectric conversion operation.

The control signal RS is set at the “H” level at time T3. Further, the word line WL0 is in the selected state at time T3. Thus, the electric charge in a beginning state of the photoelectric conversion operation immediately after reset is stored into the capacitor C.

A photoelectric conversion voltage Vref stored in the capacitor C is output after being amplified by the amplifier 30 through the data line DL.

Then, the photoelectric conversion voltages Vsig and Vref are processed in the subsequent circuits. The process is a noise removal process. As an example of the noise removal process, a CDS (Correlated Double Sampling) process is performed.

The control signal RS is set at the “L” level at time T4. Further, the word line WL0 becomes the unselected state (“L” level).

The subsequent processes are the same.

Signals on the basis of the photoelectric conversion voltages generated in the unit pixels of the same row can be obtained by the process.

It should be noted that detailed explanation of the operation of the column scan shift register 24 is omitted in the example. However, the column selection signal YST is sequentially activated, and is shifted in the column direction, so that the photoelectric conversion voltage of each unit pixel is read.

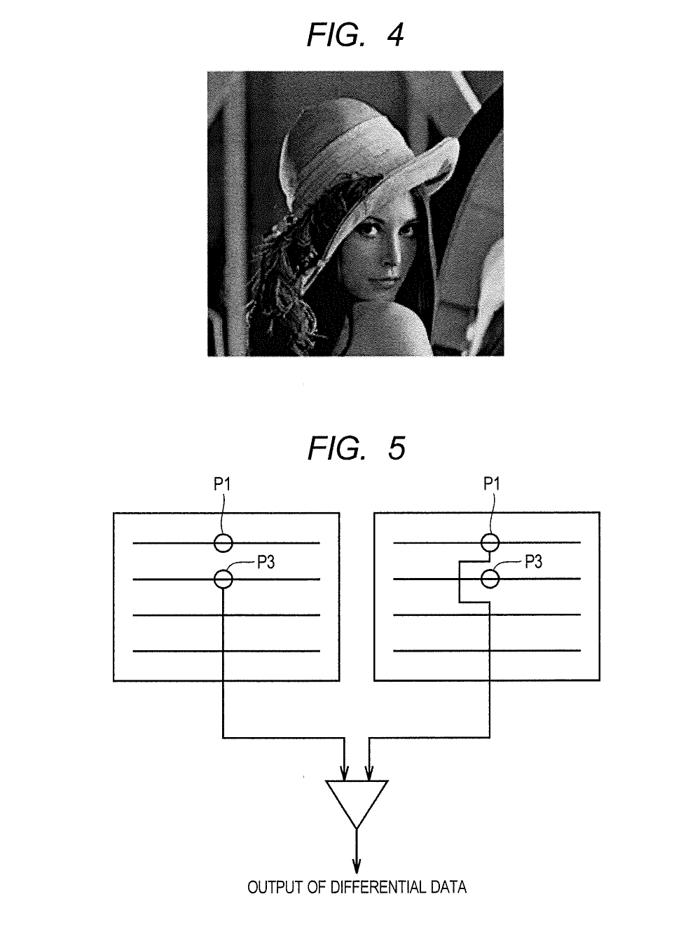

FIG. 4 is a diagram for explaining an image on the basis of image data imaged by the imaging device 1 on the basis of the first embodiment.

FIG. 4 shows an example of an image displayed on a display unit (not shown) as an example.

Specifically, FIG. 4 shows a case in which first image data on the basis of the photoelectric conversion voltage generated in each unit pixel of the pixel array unit 2 is stored into the memory, and is displayed on the display unit. A portrait image is shown as an example. The first image data is based on data of all the unit pixels of the pixel array unit 2.

On the other hand, the imaging device 1 in the first embodiment outputs second image data that is different from the first image data. Specifically, the imaging device 1 outputs differential data between the unit pixels that are adjacent to each other.

FIG. 5 is a schematic view in the case where the differential data on the basis of the first embodiment is output.

As shown in FIG. 5, the differential data of the photoelectric conversion voltages between the unit pixels P1 and P3 that are adjacent to each other in the same column is output in the example.

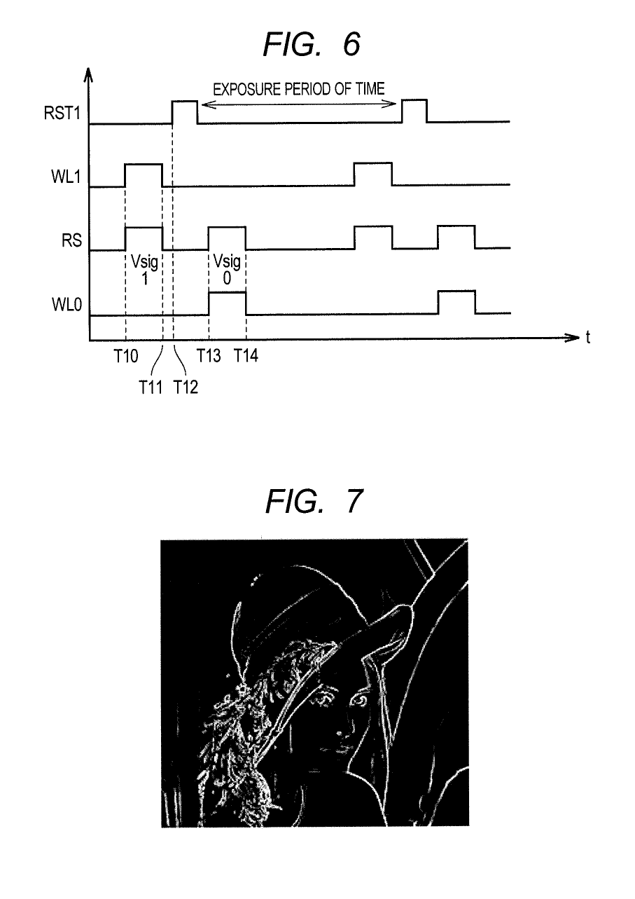

FIG. 6 is a diagram for explaining another timing chart of the imaging device 1 on the basis of the first embodiment.

In the example, the unit pixels P1 and P3 will be described.

As shown in FIG. 6, the word line WL1 is selected (“H” level) at time T10. Accordingly, each unit pixel corresponding to the word line WL1 is selected. Then, the photoelectric conversion voltage generated in the unit pixel P3 corresponding to the word line WL1 is output to the bit line.

Further, the control signal RS is set at the “H” level, and the photoelectric conversion voltage is stored into the capacitor C.

A photoelectric conversion voltage Vsig1 stored in the capacitor C is output after being amplified by the amplifier 30 through the data line DL.

The control signal RS is set at the “L” level at time T11, and the transistor RS provided between the bit line BL and the capacitor becomes a non-conductive state.

The reset line RST1 is activated to the “H” level at time T12. Accordingly, each unit pixel corresponding to the word line WL1 is reset to a beginning state of the photoelectric conversion operation.

The word line WL0 is selected (“H” level) at time T13. Accordingly, the photoelectric conversion voltage generated in the unit pixel P1 corresponding to the word line WL0 is output to the bit line.

Further, the control signal RS is set at the “H” level, and the photoelectric conversion voltage is stored into the capacitor C.

A photoelectric conversion voltage Vsig0 stored in the capacitor C is output after being amplified by the amplifier 30 through the data line DL.

Then, the photoelectric conversion voltages Vsig1 and Vsig0 are processed in the subsequent circuits in accordance with the method same as above. Data obtained by the process is the differential data between the unit pixels that are adjacent to each other.

The control signal RS is set at the “L” level at time T14. Further, the word line WL0 becomes the unselected state (“L” level).

The subsequent processes are the same.

The differential data of the photoelectric conversion voltages generated in the unit pixels that are adjacent to each other in the same column can be obtained by the process.

It should be noted that detailed explanation of the operation of the column scan shift register 24 is omitted in the example. However, the column selection signal YST is sequentially activated, and is shifted in the column direction, so that the data can be obtained in accordance with the same method.

FIG. 7 is a diagram for explaining an image on the basis of different image data imaged by the imaging device 1 on the basis of the first embodiment.

FIG. 7 shows an example of an image displayed on a display unit (not shown) as an example.

Specifically, FIG. 7 shows a case in which second image data on the basis of the photoelectric conversion voltages generated among the unit pixels of the pixel array unit 2 is stored into the memory 8, and is displayed on the display unit. Outline parts of contrast of a portrait image is shown as an example. The second image data is differential data of the photoelectric conversion voltages generated between the unit pixels that are adjacent to each other in the same column in the pixel array unit 2. In the case where the photoelectric conversion voltages of the unit pixels that are adjacent to each other are compared with each other, data at a position where the contrast largely differs can be obtained as the differential data.

Unlike the first image data on the basis of the photoelectric conversion voltages generated in all the unit pixels of the pixel array unit 2, the second image data that is the differential data on the basis of a comparison result of the photoelectric conversion voltages of the unit pixels that are adjacent to each other in the same column can be generated by the method on the basis of the first embodiment. In addition, the image data stored into the memory can be significantly compressed by storing the second image data into the memory.

It should be noted that the differential data representing the outline parts of contrast of the portrait image can be used to recognize a person by a well-known image process, and the processing load of an application (application for image verification or the like) to be used can be reduced.

It should be noted that the second image data is generated on the basis of the differential data between the unit pixels that are adjacent to each other in the same column in the above description. However, the embodiment is not particularly limited to this, but the second image data can be generated on the basis of the differential data between the unit pixels that are adjacent to each other in the same row.

The image data stored into the memory can be significantly compressed by the method.

### Second Embodiment

In a second embodiment, a method of compressing image data of a plurality of frames will be described. Specifically, the number of frames of image data is counted up, and a process is switched in accordance with the number of frames in the second embodiment.

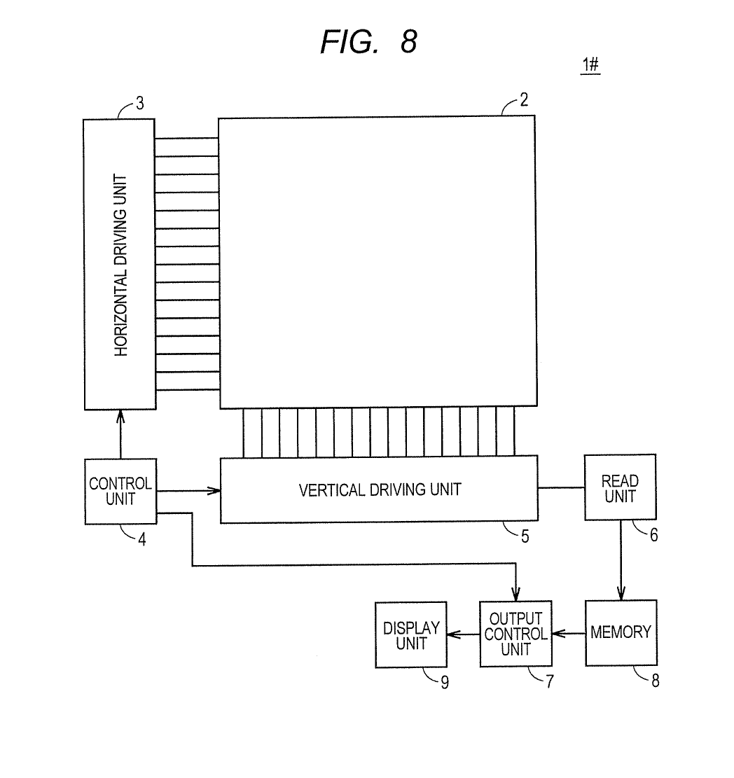

FIG. 8 is a functional block diagram for showing an entire configuration of an imaging device 1# on the basis of the second embodiment.

As shown in FIG. 8, the imaging device 1# on the basis of the second embodiment is different from the imaging device 1 described using FIG. 1 in that functional blocks of a read unit 6, a memory 8, an output control unit 7, and a display unit 9 are further added to the functional blocks of the imaging device 1.

The read unit 6 includes an amplifier 30, and stores image data read from the pixel array unit 2 into the memory 8.

The output control unit 7 reads the image data stored in the memory 8 in accordance with an instruction from the control unit 4, and outputs the same to the display unit 9.

The control unit 4 counts the number of frames of the image data read from the pixel array unit 2, and executes a predetermined image process on the basis of the count result.

Specifically, the image data of a predetermined frame number is stored into the memory 8, as it is, as first image data, and the image data up to a predetermined frame number is stored into the memory 8 as compressed second image data.

For example, the image data of the first frame is stored, as it is, into the memory 8 as the first image data. In the case of the image data of the second to fourth frames, the second image data that is differential data is stored into the memory 8. Further, the image data of the fifth frame may be stored, as it is, into the memory 8 as the first image data. Thereafter, the image data is stored in accordance with the same method.

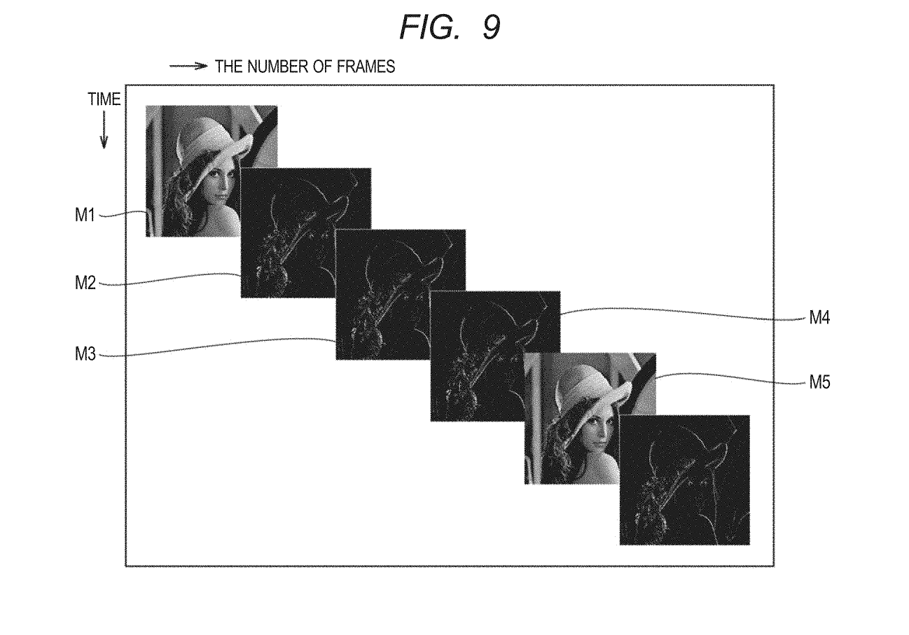

FIG. 9 shows an example of images that can be displayed on the display unit 9 on the basis of the image data stored in the memory 8 on the basis of the second embodiment.

As shown in FIG. 9, in the case of a first frame M1, the first image data on the basis of the photoelectric conversion voltages generated in the unit pixels of the pixel array unit 2 is stored into the memory 8. As an example, a portrait image is shown. The first image data is based on the data of all the unit pixels of the pixel array unit 2. In the case of a second frame M2, the second image data on the basis of the differential data of the photoelectric conversion voltages generated in the unit pixels that are adjacent to each other in the pixel array unit 2 is stored into the memory 8. In the case of a third frame M3, the second image data on the basis of the differential data of the photoelectric conversion voltages generated in the unit pixels that are adjacent to each other in the pixel array unit 2 is stored into the memory 8. In the case of a fourth frame M4, the second image data on the basis of the differential data of the photoelectric conversion voltages generated in the unit pixels that are adjacent to each other in the pixel array unit 2 is stored into the memory 8. In the case of a fifth frame M5, the first image data on the basis of the photoelectric conversion voltages generated in the unit pixels of the pixel array unit 2 is stored into the memory 8. As an example, a portrait image is shown.

The compressed data can be stored into the memory 8 by the method because the image data of the second to fourth frames is the differential data.

Thus, the image data stored into the memory 8 can be significantly compressed.

Further, the deterioration of the images can be suppressed by storing the first image data into the memory 8, as it is, on a predetermined frame number basis.

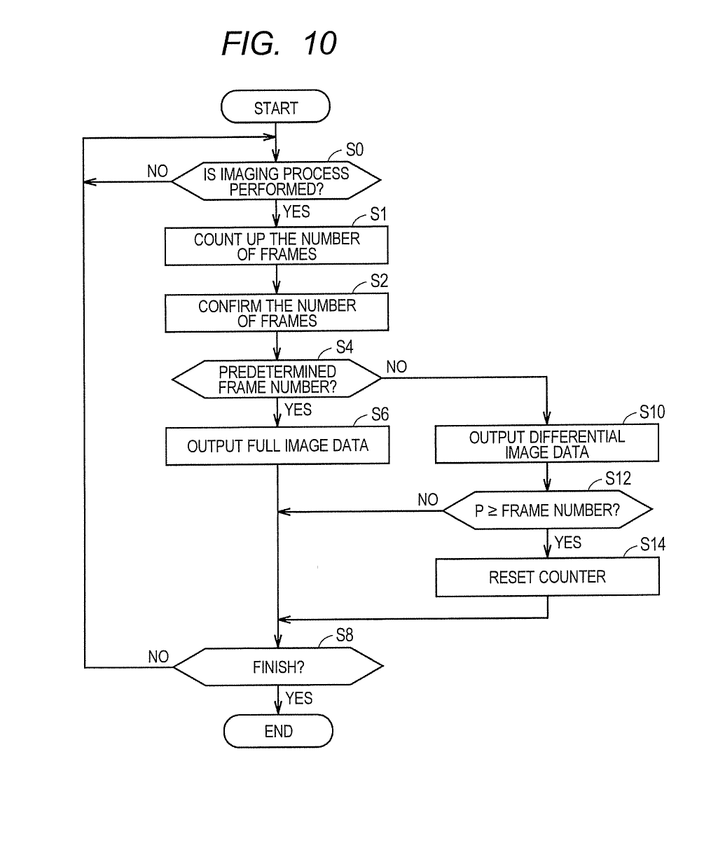

FIG. 10 is a flowchart for explaining a compression method of image data on the basis of the second embodiment.

FIG. 10 shows a process mainly performed by the control unit 4.

As shown in FIG. 10, the control unit 4 determines whether or not an imaging process is performed (Step S0).

In the case where it is determined that the imaging process is performed in Step S0 (YES in Step S0), the number of frames is counted up (Step S1). It is assumed that a counter (not shown) that counts the number of frames is provided. The initial value is 0.

Next, the control unit 4 confirms the number of frames in Step S1 (Step S2). The control unit 4 confirms the count value of the counter.

Next, the control unit 4 determines whether or not the image data is of a predetermined frame number (Step S4). In the description of the example, the predetermined frame number is set at 1. The control unit 4 confirms the count value of the counter, and determines whether or not the frame number of the image data read from the pixel array unit 2 is 1. It should be noted that the value of the predetermined frame number can be set at an arbitrary value.

Next, in the case where it is determined that the image data is of the predetermined frame number, the control unit 4 instructs to output full image data to the memory 8 (Step S6). In the case where it is determined that the image data is of the first frame, the control unit 4 executes the read process in accordance with the method described in FIG. 3, and outputs the full image data from the read unit 6 to the memory 8.

Next, the control unit 4 determines whether or not the process has been completed (Step S8).

In the case where the control unit 4 determines that the process has been completed in Step S8 (YES in Step S8), the process is finished (end).

On the other hand, in the case where the control unit 4 determines that the process has not been completed in Step S8 (NO in Step S8), the flow returns to Step S0 to repeat the above-described process.

In the case where it is determined that the image data is of not the predetermined frame number in Step S4 (NO in Step S4), the control unit 4 instructs to output differential image data (Step S10). In the case where it is determined that the image data is of not the predetermined frame number, the control unit 4 executes the read process in accordance with the method described in FIG. 6, and outputs the differential data of the photoelectric conversion voltages generated in the unit pixels that are adjacent to each other from the read unit 6 to the memory 8.

Next, the control unit 4 determines whether or not the frame number is equal to or larger than P (Step S12). As an example, P is set at 4 in the example.

In the case where it is determined that the frame number is equal to or larger than P in Step S12 (YES in Step S12), the control unit 4 resets the value of the counter (Step S14). The value is set at 0 as the initial value.

Then, the flow proceeds to Step S8.

On the other hand, in the case where it is determined that the frame number is smaller than P in Step S12 (NO in Step S12), the control unit 4 does not reset the value of the counter, and the flow process to Step S8. Then, the above-described process is repeated.

As the image data of the first frame, the full image data is stored into the memory 8 by the process. On the other hand, as the image data of the second to fourth frames, the differential image data is stored into the memory 8. After the image data of the fourth frame, the value of the frame number is set at 0. As the image data of the next frame number, the full image data is stored into the memory 8. The above-described process is repeated.

Thus, the image data of a plurality of frames to be stored into the memory 8 can be significantly compressed. It should be noted that the process can be applied to both of the image data of a still image and the image data of a video.

### Modified Example

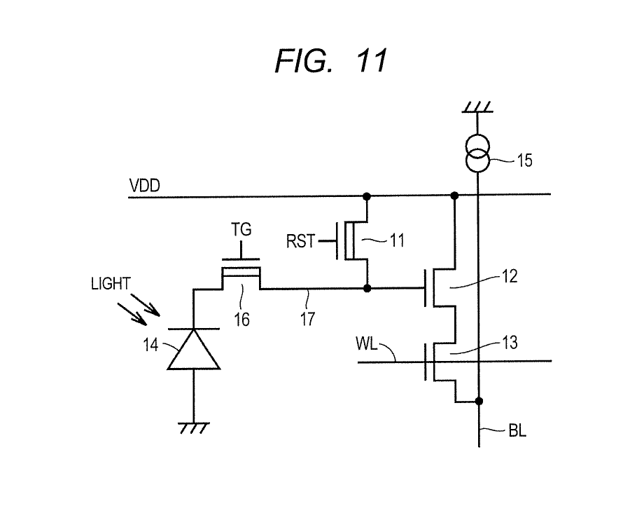

FIG. 11 is a diagram for explaining a configuration of a unit pixel on the basis of a modified example.

As shown in FIG. 11, the configuration of the unit pixel on the basis of the modified example is different from that of the unit pixel in FIG. 2 in that a transistor 16 is added. The transistor 16 is coupled between the photodiode 14 and the transistor 11, and the gate thereof accepts an input of a control signal TG. The other configurations are the same as those described in FIG. 2, and thus the detailed explanation thereof will not be repeated.

The transistor 16 always separates the photodiode 14 from a coupling point between the source of the transistor 11 and the gate of the transistor 12. When a gate signal TG becomes the high level, the transistor 16 is turned on, and couples the photodiode 14 to the coupling point.

An operation of the unit pixel in the example will be described.

In an unexposed state, the transistor 11 is activated by the reset signal RST, and the transistor 16 is activated by the gate signal TG. The photodiode 14 is initialized by being charged to the power supply voltage VDD. Then, the exposure of the photodiode 14 is started in a state where the photodiode 14 is separated from the source of the transistor 11 by turning off the gate signal TG. After an arbitrary period of time, the transistor 16 is activated again by the gate signal TG, and the photoelectric conversion voltage generated in the photodiode 14 in accordance with an input light level by the photoelectric effect of the photodiode 14 on the basis of inputting of light is read to a temporary memory unit 17 formed by the gate capacity of the transistor 12. Then, the photodiode 14 is separated from the temporary memory unit 17 by turning off the gate signal TG. Then, the voltage held in the temporary memory unit 17 is amplified by the transistor 12 forming a source follower in accordance with the transconductance gm thereof. Then, the signal amplified by the transistor 12 is output to the bit line BL by activating the transistor 13 in accordance with the word line WL.

The configuration same as above can be realized even in the unit pixel. It is obvious that the configuration of the unit pixel is not limited to the above-described configuration, but the other configurations can be employed.

The disclosure has been described above in detail on the basis of the embodiments. However, it is obvious that the disclosure is not limited to the embodiments, but can be variously changed without departing from the scope thereof.

What is claimed is:

1. An imaging device comprising:
a plurality of sensor elements which is arranged in a matrix shape and each of which generates a photoelectric conversion voltage in accordance with an input light level; and
a read circuit which is coupled to bit lines provided while being associated with respective columns of the sensor elements, and amplifies and reads the photoelectric conversion voltages generated in the sensor elements by being exposed at predetermined timing,
wherein the read circuit outputs differential data of the read photoelectric conversion voltages generated in the respective sensor elements that are adjacent to each other in the same row or column.

2. The imaging device according to claim 1, further comprising a memory into which the data output from the read circuit is stored.

3. The imaging device according to claim 2, further comprising a display unit displaying the data stored in the memory.

4. The imaging device according to claim 1,
wherein the read circuit outputs the differential data of the read photoelectric conversion voltages generated in the respective sensor elements that are adjacent to each other in the same row or column, or image data on the basis of the photoelectric conversion voltages generated in the sensor elements.

5. The imaging device according to claim 4,
wherein the read circuit outputs the differential data of the read photoelectric conversion voltages generated in the respective sensor elements that are adjacent to each other in the same row or column at predetermined frame intervals, and otherwise, outputs the image data on the basis of the photoelectric conversion voltages generated in the sensor elements.

6. The imaging device according to claim 1,
wherein each of the sensor elements includes:
a photodiode;
a first transistor that initializes the photodiode in accordance with a reset signal;
a second transistor that amplifies the photoelectric conversion voltage to be output to the corresponding bit line in the case where the second transistor is coupled between a power supply and the bit line; and
a third transistor that couples the second transistor to the corresponding bit line in accordance with a control signal.

7. The imaging device according to claim 6,
wherein each of the sensor elements further includes a fourth transistor that couples the sensor element to the first transistor in accordance with a gate signal.
